(19) United States
(12) Patent Application Publication
(10) Pub. No.: US 2008/0137760 A1
(43) Pub. Date: Jun. 12, 2008

(54) Method For Transmitting Signals in a Communication System

(75) Inventors: Andreas Forck, Berlin (DE); Thomas Haustein, Munchen (DE); Volker Jungnickel, Berlin (DE); Stefan Schiffemuller, Potsdam (DE); Wolfgang Zirwas, Munchen (DE); Clemens Von Helmolt, Berlin (DE)

Correspondence Address: STAAS & HALSEY LLP, SUITE 700, 1201 NEW YORK AVENUE, N.W., WASHINGTON, DC, 20005, US

(73) Assignees: SIEMENS AKTIENGESELLSCHAFT, Munich (DE); HOFER GESELLSCHAFT ZUR FOERDERUNG DER ANGEWANDTEN, Munich (DE)

(21) Appl. No.: 11/572,492

(22) PCT Filed: Jul. 20, 2005
(86) PCT No.: PCT/EP2005/053508

§ 371 Date: Dec. 19, 2007

(30) Foreign Application Priority Data
Jul. 20, 2004 (DE) 10 2004 035 018.3

(51) Int. Cl. H04L 27/28

(52) U.S. Cl. 375/260

(57) ABSTRACT

Signals having an antenna-individual training sequence are transmitted from at least two transmitting antennas in a transmitting station of a communications system. The training sequences are formed in such a manner that the respective transmitting antenna can be identified on the receiving side based on the training sequence.

### CROSS REFERENCE TO RELATED APPLICATIONS

This application is based on and hereby claims priority to German Application No. 10 2004 035 018.3 filed on Jul. 20, 2004, the contents of which are hereby incorporated by reference.

### BACKGROUND

The invention relates to a method for transmitting signals in a communication system, especially within the framework of what is known as MIMO-OFDM signal transmission.

Different methods are used for resource allocation and for multiplexing in communication systems. In addition to multiplexing in the time domain (Time Division Multiplex, TDM) and code domain (Code Division Multiplex CDM) different frequency channels are implemented by the FDM (Frequency Division Multiplex) method. In the FDM method a wide frequency spectrum is divided up into many separate frequency channels in the frequency domain, each with a narrow bandwidth, which produces a defined frequency channel grid through the spacings between the carrier frequencies. Advantageously with this arrangement a number of subscribers can be served simultaneously on different frequency channels and the resources can be adapted to the individual needs of the subscribers. A sufficient spacing between the frequency channels ensures in this case that interference between the channels can be reduced and controlled.

Future wired and radio communication systems will increasingly use so-called OFDM (Orthogonal Frequency Division Multiplexing)-based signal transmission. OFDM performs a block modulation in which a block with a number of information symbols is transmitted in parallel on a corresponding number of subcarriers. With radio communication systems this can be done in an expansion of existing third-generation systems, for example UMTS, and/or as self-contained WLAN (Wireless Local Area Network)-based systems, for example HiperLan/2.

A further development based on OFDM transmission relates to a combination of OFDM and what is known as MIMO (Multiple Input Multiple Output), i.e. transmitting and receiving over a number of paths using a number of transmit and receive antennas in each case at the stations communicating with each other. The combination of MIMO with OFDM, referred to in this document as MIMO-OFDM, advantageously enables the complexity of the space-time signal processing to be reduced. In this case the transmission channel is orthogonalized by the OFDM component in the frequency domain, as a result of which a non-frequency-selective so-called “flat” channel is produced for each individual subcarrier. Based on subcarriers, comparatively simple algorithms can be used for the “flat” MIMO channel in order to separate the spatially overlaid data streams again on the receive side. Basic algorithms for the described combination of MIMO and OFDM are for example known from G. G. Raleigh and J. M. Cioffi, “Spatio-Temporal Coding for Wireless Communications”, IEEE Trans. Comm., Vol. 46, No. 3, 1998.

Despite a simplification by comparatively simple algorithms, the implementation of a receive-side real time processing of MIMO-OFDM still represents a great challenge. Estimations show a processing power required for conceivable future systems, for example MIMO-OFDM with 48 subcarriers in the 16 MHz bandwidth with 4 transmitters and 4 receivers, to be in the order of at least 10⁹ operations per second. This means that MIMO-OFDM lies well above the processing power of current digital signal processors (DSP). However, if only DSPs were used the maximum data rate as a result of a sequential processing of the algorithms would be limited to a few Mbit/s, which is well below the data rates of at least 100 Mbit/s demanded for practical applications of these types of systems.

More recent approaches are based on the use of FPGAs (Field-Programmable Gate Arrays) or ASICs (Application Specific Integrated Circuits), on which at least a part of the algorithms can be executed in parallel. Only approaches such as these potentially allow processing of data rates in the range of 100 Mbit/s and above. However in these cases the signal processing must be restricted to a few elementary functions such as addition, multiplication and complex functions by using lookup tables, which can be implemented in these circuits in parallel as specialized hardware components. It should be noted in such cases that many known algorithms have been developed for a sequential processing on a DSP, but these are often not suitable for porting unchanged to FPGAs or ASICs.

In the article by G. L. Stüber, J. R. Barry, S. W. McLaughlin, Y. (G.) Li, M. A. Ingram, and T. G. Pratt, “Broadband MIMO-OFDM Wireless Communications,” Proc. IEEE, vol. 92, no. 2, pp. 271-294, 2004, a real-time capable MIMO-OFDM system is presented but does not however realize a space division multiplex. Instead the same information is transmitted in accordance with the known Alamouti scheme over two transmit antennas simultaneously. Because of the spatial diversity a higher security is achieved for transmission but no increase in the data rate is achieved. Furthermore, because the system is implemented on the basis of a number of DSPs, the data rate is limited to a few Mbit/s. The combination of MIMO and OFDM is explained in detail once again, especially in Chapter 1 of this article.

### SUMMARY

An aspect is to specify a method and also system components which make possible real-time processing for a MIMO-OFDM transmission at high data rates.

In accordance with the above, a transmitting station of a communication system features at least two transmit antennas, via which signals are transmitted with an antenna-individual training sequence, with the training sequences being designed such that the transmit antennas can be identified on the receive side using the training sequence.

Advantageously the design of the training sequences allows a low-cost and thus real-time capable receive side channel estimation by a correlation in the time domain.

The method is in particular used advantageously for a MIMO-OFDM transmission.

In accordance with a development of the method a length of the training sequences is selected as a function of the number of transmit antennas. This advantageously allows the receive-side estimation error to be kept constant. The length of the training sequence should advantageously be negotiated between the transmitting and the receiving station before a MIMO-OFDM transmission is established.

As a result of a further embodiment the training sequences are modulated for individual antennas with orthogonal codes, which means that the training sequences of antennas in the time domain are orthogonal to each other. This code-multiplex approach advantageously makes it possible to minimize the receive-side estimation error in the channel estimation. Preferably known Hadamard sequences are used as orthogonal codes, which, because of their recursive structures, once again form orthogonal sequences even if there is a variation in the sequence length.

In accordance with a further development the training sequences are formed exclusively from binary values for the real and/or imaginary part. This advantageously allows a simpler circuit to be implemented, since multiplication operations are replaced by less complex addition and subtraction operations.

As a result of a further embodiment the training sequences are scrambled in the frequency domain, especially by being multiplied by a binary sequence in each case. This retains the advantageous binary structure of the preamble in accordance with the previous development and the dynamic of the transmit signal is advantageously restricted.

In accordance with a further development of the method the real and imaginary parts of a transmit signal are marked with a relevant sequence of a set of orthogonal frequencies, by which a correction of the imbalance between real and imaginary part is made possible on the receive side.

### BRIEF DESCRIPTION OF THE DRAWINGS

These and other objects and advantages will become more apparent and more readily appreciated from the following description of the exemplary embodiments, taken in conjunction with the accompanying drawings of which:

FIG. 1 are graphs of real and imaginary parts of a training sequence for a first transmit antenna,

FIG. 2 are graphs of real and imaginary parts of a training sequence for a second transmit antenna,

FIG. 3 is a frequency-time grid with a re-use of correlation circuits,

FIG. 4 is a block diagram of a star-configuration linkage of a number of DSPs to an FPGA,

FIG. 5 is a graph of simulations and measurements of times for a calculation of weighting matrices depending on the number of transmit antennas,

FIG. 6 logical block diagram for a pipeline structure of a matrix vector multiplier unit for four inputs and outputs respectively,

FIG. 7 is a record layout for address fields for addressing weighting matrices in an FPGA,

FIG. 8 is a block diagram of a transmit device, and

FIG. 9 is a block diagram of a receive device.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

An example of an implementation of a MIMO-OFDM transmission link between two stations with a number of transmit and receive antennas in each case is described below. Preferably the system is able to be implemented on a hybrid software radio platform consisting of a FPGA and one or more DSPs. An uncomplicated implementation is especially advantageous for a low-cost use in different applications, such as for example for wireless local networks (WLAN—Wireless LAN) with very high data rates of 100 Mbit/s to 1 Gbit/s, for a so-called fixed wireless access (FWA) or for increasing the data rate in the wired subscriber access area, for example DSL (digital subscriber line).

A possible realization of the invention will be explained below on the basis of four steps, without however being limited to these steps. A definition of a training sequence or preamble for the receive-side channel estimation, an uncomplicated conversion of the channel estimation on the basis of this training sequence, a calculation of weights and finally a data reconstruction are explained.

Based on an assumed frame structure of a HiperLan/2 system with a length of 21 ms, known A and B preambles of which the uses include a receive-side synchronization as well as the determination of a frequency offset, are used for all transmit antennas to maximize an average signal-to-noise ratio (SNR) at the receiver. However, new preambles are defined as training sequences for receive-side channel estimation or determination of channel coefficients which make it possible to distinguish between the channels of different transmit antennas at the receiving antennas as well as to simplify processing.

The aim of the definition of the preamble or training sequence for channel estimation is to make possible an estimation of a transmission channel without interpolation errors. Estimation errors should in this case arise only because of receiver noise, and the size of the error should be able to be influenced by variation of the sequence length. To this end a training sequence which is in principle the same is transmitted on all subcarriers of a given transmit antenna, with the entire training sequence being distributed over a variable number K of consecutive OFDM symbols, with K for example able to be a value of up to 64.

Initially the correlation in the time domain is considered. A receiver signal at the ith receive antenna on the nth subcarrier is given as the sum of all transmitted signals on this subcarrier multiplied by the respective channel coefficients

$${Y}_{n}^{i} ( {t}_{k} ) = {\sum }_{j = 1}^{{N}_{TX}} {H}_{n}^{ij} \cdot {x}_{n}^{j} ( {t}_{k} ) + {n}_{n}^{i} ( {t}_{k} ) , \qquad ( 1 )$$

with the index k giving sequence numbers to the consecutive OFDM symbols, Hₙ^{ij} designating the channel coefficients to be estimated and nₙⁱ(tₖ) the receiver noise.

The training sequences xₙ^{h}(tₖ) are characteristic for each transmit antenna (j=1 . . . N_{Tx}, N_{Tx}: Number of transmitters, i=1 . . . N_{Rx}, N_{Rx}: Number of receivers). They are normalized so that

$${\sum }_{j = 1}^{{N}_{Tx}} {\sum }_{n = 1}^{{N}_{c}} {\vert {x}_{n}^{j} ( {t}_{k} ) \vert}^{2} = 1 \qquad ( 2 )$$

applies, with N_{c} indicating the number of carriers. With such a structure a channel estimation by correlation in the time domain, i.e. over a number of consecutive OFDM symbols, can now be undertaken.

$$\begin{matrix}{\hat{H}}_{n}^{il} = \frac{{N}_{Tx} \cdot {N}_{c}}{K} {\sum }_{K = 1}^{K} {x}_{n}^{* l} ( {t}_{k} ) \cdot {Y}_{n}^{i} ( {t}_{k} ) \\ = \frac{{N}_{Tx} \cdot {N}_{c}}{K} {\sum }_{j = 1}^{{N}_{Tx}} {H}_{n}^{ij} \cdot {\sum }_{k = 1}^{K} {x}_{n}^{* l} ( {t}_{k} ) \cdot {x}_{n}^{j} ( {t}_{k} ) + \\ \frac{{N}_{Tx} \cdot {N}_{c}}{K} {\sum }_{K = 1}^{K} {x}_{n}^{* l} ( {t}_{k} ) \cdot {n}_{n}^{i} ( {t}_{k} )\end{matrix} \qquad ( 3 )$$

Under the condition that the selected frequencies are orthogonal in the time domain

$${\sum }_{k = 1}^{K} {x}_{n}^{* l} ( {t}_{k} ) \cdot {x}_{n}^{j} ( {t}_{k} ) = \frac{K}{{N}_{Tx} \cdot {N}_{C}} \cdot {δ}^{l j} \qquad ( 4 )$$

with δ^{lj} being the Kronecker symbol (δ^{lj}=1 for 1=i and δ^{lj}=0 otherwise), the following equation is produced

$${\hat{H}}_{n}^{il} = {H}_{n}^{il} + \frac{\sqrt{{N}_{Tx} \cdot {N}_{c}}}{K} {\sum }_{k = 1}^{K} {s}_{n}^{* l} ( {t}_{k} ) \cdot {n}_{n}^{i} ( {t}_{k} ) \qquad ( 5 )$$

the power of the binary training sequences |sₙ^{j}(tₖ)|² is in this case normalized to 1 at each point in time tₖ. Statistics and amplitude of the Gaussian noise are not changed by multiplication by a complex number normalized in this way. If the noise is now described as a random process

$${n}_{n}^{i} ( {t}_{k} ) = \sqrt{\frac{1}{{N}_{C} \cdot SNR} {r}_{n}^{i} ( {t}_{k} )} \qquad ( 6 )$$

in which SNR stands for a signal-to-noise ratio and r for a complex Gaussian random number with a variance of 1, the sum in (5) is simplified to

$${\hat{H}}_{n}^{il} = {H}_{n}^{il} + \sqrt{\frac{{N}_{Tx}}{K \cdot SNR} {N}_{n}^{il}} \qquad ( 7 )$$

This means that the variance of the estimation error is also known (N_{Tx}/(K*SNR)), and N is a complex Gaussian random number with the variance 1.

From equation (7) it can now be derived, that on adaptation of the length of the preamble K to the number of transmit antennas N_{Tx}, the estimation error can be kept constant. A preamble with variable length K which can be used for this will be described below at greater length.

To be able to re-use a correlation circuit for all carriers, the same sequence should also be used in the time domain on all subcarriers n, i.e. distributed over a number of OFDM symbols. This advantageously reduces the effort for the MIMO-OFDM channel estimation by the factor N_{c}.

Next, the use of binary sequences in the frequency domain will be explained. The correlation from equation (3) features a large number of multiplications. Although these can be represented in hardware circuits in the interests of a highest possible processing speed, only as restricted a number of multiplications as possible should be implemented in hardware. Thus, instead of any number of complex sequences sₙ^{j}(tₖ), those forms of signal should be selected in which real and/or imaginary part only assume binary values, i.e. {−1, +1}. This enables the multiplications in equation (3) to be seen as a change of leading sign of the real or imaginary part to be summed which can be implemented by a switchover from addition to subtraction or vice versa in a greatly simplified manner. Multiplication operations are thus no longer necessary for the channel estimation.

A third step relates to a scrambling in the frequency domain. The use of the same sequence on all subcarriers described above would lead to all subcarriers being occupied with an equal value for each OFDM symbol. The Inverse Fast Fourier Transformation (IFFT) on the transmit side would consequently synthesize a short Dirac impulse with an amplitude N_{c}. In order to prevent this, a scrambling of the sequences in the frequency range is performed. This can be realized for the C preamble in Hiperlan/2 or IEEE 802.11a-based systems for example by multiplication by a subcarrier-individual binary sequence. This advantageously preserves the binary structure of the preamble previously recognized as advantageous and the dynamic of the transmit signal will again be restricted to a usual range. On the receiver side the scrambling must be reversed again before the channel estimation by a corresponding change of leading sign of the sequence.

For independent estimation of the I and Q branch an allocation of different sequences to the I and Q branches of the complex-value transmit signal is also conceivable.

A fourth step is concerned with a correction of the so-called IQ imbalance. This occurs for example because of a comparatively simple circuit design in the radio frequency range with direct up and down conversion. The imbalance disadvantageously causes a coupling between received signals in the upper and lower sideband. The corresponding transmit and receive circuits exhibit an imbalance, which must be estimated and compensated for by the signal processing. In the time domain the calibration can be performed relatively simply, however explicit knowledge of the parameters of the imbalance must be available. By contrast, in the frequency domain the channel estimation is corrected, with however no explicit knowledge of the parameters having to be available.

Three approaches can be identified for correcting the IQ imbalance.

In accordance with a first approach a calibration is performed in advance for each individual transmitter and receiver and the imbalance is corrected separately in each baseband unit. This disadvantage of this approach however is that considerable costs arise for the calibration which hinder a practical implementation.

As a result of a second approach, the real and imaginary part of each transmit signal in the time domain is marked with a separate sequence from the same orthogonal set of sequences, and the imbalance is corrected by real-value MIMO signal processing, with each I and Q branch of each transceiver being taken as a virtual antenna. The system operates in this case with a real-value channel matrix with twice the number of virtual transmit and receive antennas.

In accordance with a third approach the coupling between the received signals in the upper and lower sideband is estimated and corrected by common processing of the subcarriers as well as a corresponding image subcarrier, in accordance with the method described in the article by T. M. Ylamurto “Frequency Domain IQ Imbalance Correction Scheme for OFDM system”, Proc. WCNC 2003, New Orleans, USA.

For this purpose each of the symbols of the preamble is split into two symbols, so that only subcarriers in the upper sideband can be used during the odd symbols. The direct channel coefficients are then estimated in the upper sideband, whereas the cross-talk coefficients are estimated in the lower sideband. By contrast the reverse correspondingly applies during the even symbols and only the subcarriers of the lower sideband are used to estimate the direct channel coefficients.

If the previously described steps and the requirement from equation (4) are combined, the pilot sequences for the jth transmit antenna are produced for

sₙ^{j}(tₖ)=Sₙ·Oⱼ(tₖ) (8-I)

for calibrated transceivers corresponding to the first approach or

$${s}_{n}^{j} ( {t}_{k} ) = \frac{{S}_{n}}{\sqrt{2}} \cdot ( {O}_{2 j - 1} ( {t}_{k} ) + j \cdot {O}_{2 j} ( {t}_{k} ) ) \qquad ( 8 \text{-} II )$$

for uncalibrated transceivers corresponding to the second approach, and

$${s}_{n}^{j} ( {t}_{k} ) = \frac{{S}_{n}}{\sqrt{2}} \cdot {O}_{j} ( {t}_{k} ) \qquad ( 8 \text{-} III )$$

corresponding to the third approach. In this case Oₓ are sequences from an orthogonal set of sequences, for example known Hadamard sequences. Hadamard sequences are only known for K=2^{m} (m≧1).

The xth row from the quadratic Hadamard matrix can be advantageously used for Oₓ for example. Generally Hadamard sequences have the advantageous characteristic of being able to be represented recursively. If Hₘ designates the Hadamard matrix with 2^{m} columns and rows in each case, H₁=1 can be used to create all larger Hadamard matrices with the specification

$${H}_{m} = ( \begin{matrix}{H}_{m - 1} & {H}_{m - 1} \\ {H}_{m - 1} & - {H}_{m - 1}\end{matrix} ) . \qquad ( 9 )$$

Since the respective original matrices (Hₘ₋₁) appear unchanged in the top left corner of a new matrix, the first 2^{m-1} Hadamard sequences with halved length also again form a (smaller) set of sequences orthogonal to each other.

If Hadamard matrices are also selected as the basis for the time domain structure of the training sequences in equation (8), and j is numbered consecutively in accordance with the number of antennas, the length of the preamble, i.e. the number of OFDM symbols required for the channel estimation, can be reduced, by K being reduced by powers of 2. A variance of the estimation error increases in this case by the same factor.

Based on the equation (4) and the fourth step, at least N_{Tx} (first and third approach) or 2·N_{Tx} frequencies (second approach) must thus be used. The variable length of the training sequences can advantageously be used to set the quality of the channel estimation with different antenna arrangements, according to equation (7), and to fulfill requirements of the transmission method used in relation to the quality of the channel estimation.

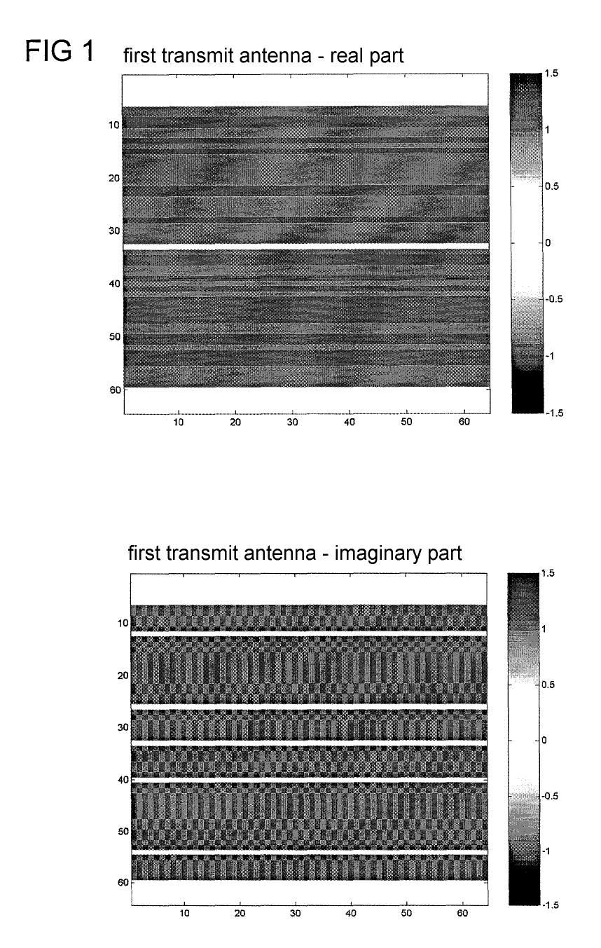

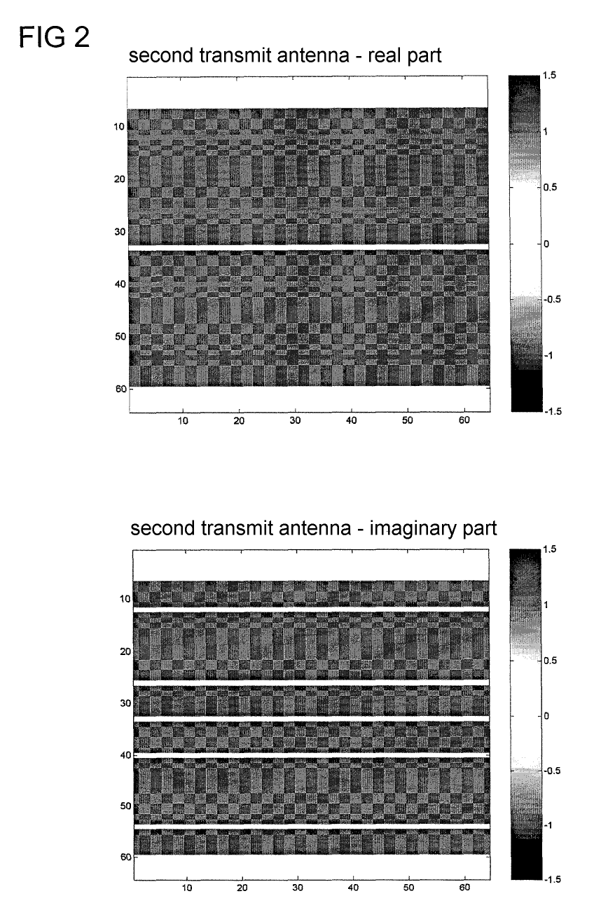

FIGS. 1 and 2 show examples of a relevant structure of the real and imaginary part of a preamble with K=64 in the time-frequency level for a first and a second assumed transmit antenna corresponding to the equation (8-II). In these diagrams a subcarrier or frequency index is plotted on the vertical axis and a time index in units of 4 μs on the horizontal axis. Each column corresponds to an OFDM symbol and each row to a subcarrier. In accordance with the Hiperlan/2 Standard, a maximum number of 64 OFDM symbols is shown for the training sequence. Of the 64 possible subcarriers shown only 52 are used in the example. In the edge areas the carriers 1 to 6 and 60 to 64 as well as the center carrier no. 33 are not used. Furthermore pilot signals are provided in the subcarriers 12, 26, 40 and 54 which feature purely real values (1,1,1,−1) and are used to adjust the carrier phase. Accordingly a constant signal is represented on these subcarriers over time, whereas no signal exists in the imaginary part.

It can be seen from FIG. 1 that the real part of the first antenna remains constant on all subcarriers over time, which is a characteristic feature of the first Hadamard sequence. The imaginary part by contrast changes its leading sign from OFDM symbol to OFDM symbol. With the second antenna in FIG. 2 real and imaginary part only change in every second OFDM symbol, with the changes being shifted in relation to one another by a symbol duration. The vertical frequency axis shows the scrambling on the basis of leading signs changing at irregular intervals.

An example for an uncomplicated implementation of the receiver-side channel estimation is described below. N_{Tx}·N_{Rx}·N_{c} complex correlations corresponding to the equation (3) are required for the complete MIMO-OFDM channel estimation. Were an individual circuit to be implemented for each correlation, the limits of currently available FPGAs would be exceeded. In accordance with equation (3) a correlation over a number of consecutive OFDM symbols must furthermore be executed.

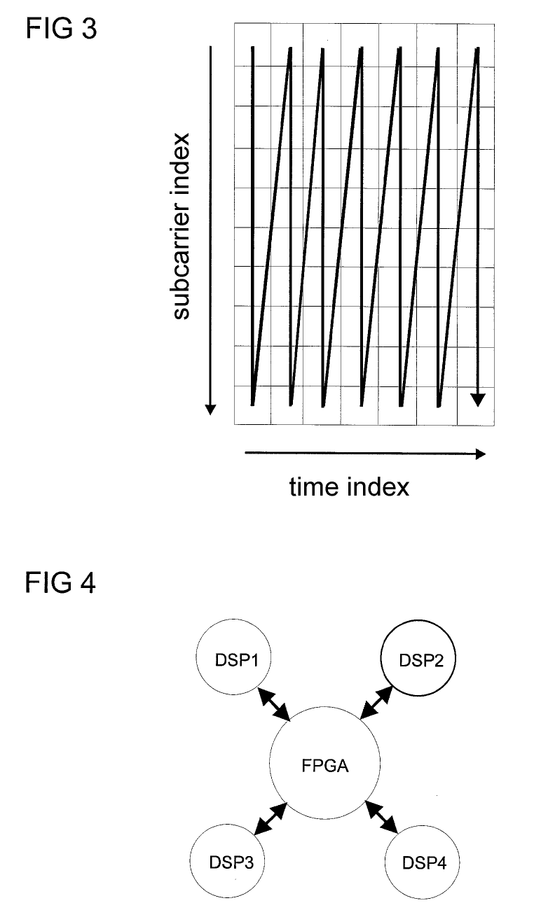

To reduce the outlay, as described above, the same signals are used as training sequences, apart from the additional scrambling in the frequency range, on all subcarriers. This advantageously enables only N_{Tx}·N_{Rx}-correlation circuits with the assistance of an intermediate memory to be used, which reduces the hardware complexity for implementation to an order of magnitude currently able to be realized. The underlying procedure is shown in FIG. 3.

FIG. 3 once again shows a frequency-time level, this time however taking into account the receiver side. Each column corresponds to an OFDM symbol (time index) and each row to a subcarrier (subcarrier index). The receiver-side unit for the Fast Fourier Transformation (FFT) matrix outputs the signals received on the respective subcarriers serially, with real and imaginary part being available simultaneously. This is shown in FIG. 3 by a rising and falling zig-zag line. In accordance with equation (3) the correlation in each subcarrier is undertaken OFDM symbol by OFDM symbol i.e. in the time domain.

The aim of the implementation is now to re-use the correlation circuits where possible for all subcarriers to be considered. To this end first of all the send-side scrambling is reversed, for example by a change of leading sign of the receiver signal corresponding to the sequence Sₙ. Subsequently use is made of the fact that all subcarriers of a transmit antenna are modulated in the time domain with the same sequence. This finally enables the same correlation circuit to be used for all subcarriers, only the relevant intermediate result has to be stored in a memory of length N_{c} in this case.

If for example a specific subcarrier n is to be processed at a specific point in time tₖ, the last intermediate result for the subcarrier n is read out of the memory (1st operand), depending on the current value of the Hadamard sequence if necessary the leading sign of the receive signal (2nd operand) exchanged in this subcarrier for the current OFDM symbol, the two values added and the result stored n the memory again. The first two steps in this case can be executed in parallel; the last two steps however are executed sequentially.

This increases the necessary clock frequency by the factor three, which is however not critical for symbol rates of 20 MHz in accordance with the Hiperlan/2 or IEEE 802.11a Standards. With a very much higher symbol clock, for example in the order of 100 MHz, the described process can be executed in a number of parallel pipelines sequentially in each case for a number of consecutive subcarriers. In this case one pipeline is typically responsible for a subcarrier, with the individual operations in a pipeline being executed in succession. The channel estimation in the individual pipelines can be initiated consecutively in accordance with the number of the subcarrier.

As a result only additions are advantageously required for the MIMO-OFDM channel estimation, and the same correlation circuits can be re-used for all carriers because of the structure of the training sequence. The channel estimation is perfect, to the extent that a result without systematic errors is present for each subcarrier. The method also advantageously does not create any interpolation errors. The result of the estimation is available immediately after the execution of the C preamble or training sequence for further processing, and by contrast with the method cited in the article by Stüber et al at the start of this document, there are no additional delays. With the method proposed in this article, after the FFT at the receiver a matrix inversion and an IFFT are used in order to only have to transmit pilot signals on a reduced number of subcarriers.

The calculation of weighting matrices is described below. The calculation of weighting matrices for linear and non-linear MIMO detection methods requires a large number of matrix inversions in a very short period of time. Thus for example the weighting matrices Wₙ in the known linear zero-forcing method are given by the pseudo-inverse of the channel matrices in the nth subcarrier:

Wₙ=Hₙ⁺=(Hₙ^{H})⁻¹Hₙ^{H}. (10)

The matrix inversion in the equation (10) can be calculated with known algorithms, such as Gauss-Jordan for example; however specific methods such as Greville can also be used which lead directly to the pseudo-inverse matrix. These algorithms can however, because of their sequential structures, only be implemented directly in an FPGA with difficulty. A simpler implementation is possible on the other hand in a conventional microprocessor or DSP. Furthermore high demands are imposed both on the coupling between DSP and FPGA and also on the programming of the DSP, since the channel coefficients for each individual subcarrier have to be re-estimated and adjusted and also the weighting matrices calculated within a period of typically less than 1 ms.

First of all the results of the channel estimation are read into a DSP, which, as previously mentioned, requires fast coupling between DSP and FPGA. Practical OFDM systems as a rule use a very large number of subcarriers. Thus the Standards HiperLan/2 and IEEE 802.11a for example use 48 subcarriers, whereas the IEEE 802.16 Standard uses 256 subcarriers and future radio communication systems of the fourth generation are likely to use 512 to 1024 subcarriers. For an IEEE 802.11a-based system with two transmitters and two receivers, with simultaneous correction of the IQ imbalance, 16×48=768 channel coefficients with a resolution of for example 12 bits must be transmitted. With a 24-bit wide bus at an effective clock rate of 10 MHz, this data volume can be transmitted in a time of 38 μs. With higher numbers of antennas, for example four transmit and receive antennas with 48 subcarriers, the time required already amounts to 307 μs, and with for example 200 subcarriers the required time amounts to 1.3 ms. These require a wide bus and if necessary a significantly higher effective clock frequency. The fastest possible access by the DSP to registers in the FPGA is also required.

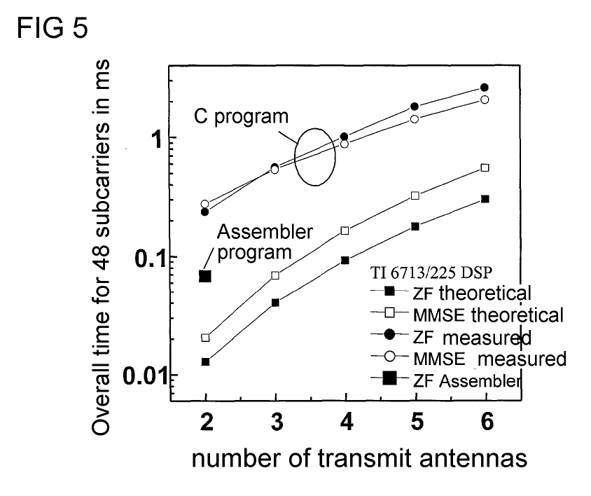

Especially for systems with a large number of subcarriers, use of a number of DSPs connected in parallel makes sense, with each DSP being responsible for example for a specific subgroup of subcarriers and being linked individually to the FPGA. A typical implementation in the form of a star structure with an FPGA as node is shown in FIG. 4. Using an arrangement of this type enables the above-mentioned load times for the channel estimation results in the matrices Hₙ from the FPGA into the memory of the DSP and the storage times for the weighting factors in the matrices Wₙ from the DSP into the FPGA to advantageously be reduced.

Furthermore a largely asynchronous access by the DSP or DSPs to the FPGA is to be advantageously guaranteed. Whereas the execution sequences in the FPGA are oriented to the frame structure of the send signal, the read, arithmetic and write operations in the DSP should be implemented largely independently of this. This can be done by the channel estimation results being copied immediately after the end of the channel estimation from the intermediate storage of the accumulator into a second memory (1:1 copy). Only for the short period of making the copy does the DSP in this case have no access to the FPGA. The weighting matrices are transmitted in a similar manner. The DSP again initially writes the results into an intermediate storage, from where at the next possible point in time, at which no data will be transmitted—in general during the transmission of preambles—it is copied into the registers used by data reconstruction. By this largely asynchronous design, the execution sequences in FPGA and DSP can be largely decoupled from one another, which advantageously simplifies the programming.

In a DSP weighting matrices are calculated and results are transmitted back to the FPGA again. Since the weighting matrices for all subcarriers, as mentioned above, must be calculated in a very short period of typically 1 ms, to enable a temporal change of the channel coefficients to be followed, very high processing power is required. Theoretical values for 48 subcarriers and four transmit and receive antennas in each case are around 100 million floating-point operations per second. Since practical values with non-optimized C-code are mostly far higher than this, the implementation of the algorithms should be matched as well as possible to the internal structure of the DSP, to get as close as possible to these theoretical values.

The algorithms should further be implemented in such a way that consecutive tasks which cannot be dealt with in one process step, for example multiplication, are organized in such a way as to make efficient use of processor-internal pipelines. In this way the effective processing time for consecutive identical operations still only corresponds to one cycle. In addition explicit use should be made of opportunities to likewise handle processes such as addition, address computation and memory access in one cycle. Other critical operations are division operations, which are initially only available as 8-bit estimated values. The known Newton-Rhapson algorithm can for example be used advantageously in this case, since this provides a significantly more accurate result in few additional cycles.

The totality of the previously described measures enables the calculation times to be reduced by using hardware-related optimized DSP codes by almost two orders of magnitude compared to a non-optimized C code. These optimizations advantageously make it possible to implement currently discussed systems, for example an expansion of the IEEE 802.11a Standard by MIMO-OFDM, based on one or just a few currently available DSPs. Results of such optimizations are typically shown in FIG. 5. In this diagram a total time in ms for 48 subcarriers is plotted logarithmically on the vertical axis, and a number of transmit antennas is plotted on the horizontal axis. One of the things that is evident from the graphs is that, even with programming in machine code (Assembler) the practically determined values on a DSP of the type Texas Instruments (TI) 6713, 225 MHz, are still higher than the theoretically possible values by a factor of around six. For a program programmed in the C programming language and additionally optimized manually this factor amounts to approximately ten. In the times shown, loading and storage operations from the memory of the DSP into a cache memory and back are also taken into account. For a typical configuration with four transmit and receive antennas overall times of appr. 1 ms can thus be achieved with currently available DSPs. As the development of DSPs advances correspondingly larger numbers of antennas will be able to be processed in this overall time.

Before a typical implementation of the method in a MIMO-OFDM-based radio communication system is presented, the receive-side reconstruction of the data signals will first be described below.

The data signals are reconstructed on the basis of the weighting matrices Wₙ calculated by a linear matrix vector multiplication for each carrier. Using equation (1) as the starting point, this can be represented by the total

$${\hat{X}}_{n}^{j} ( {t}_{k} ) = {\sum }_{j = 1}^{{N}_{Rx}} {W}_{n}^{ji} \cdot {Y}_{n}^{i} ( {t}_{k} )$$

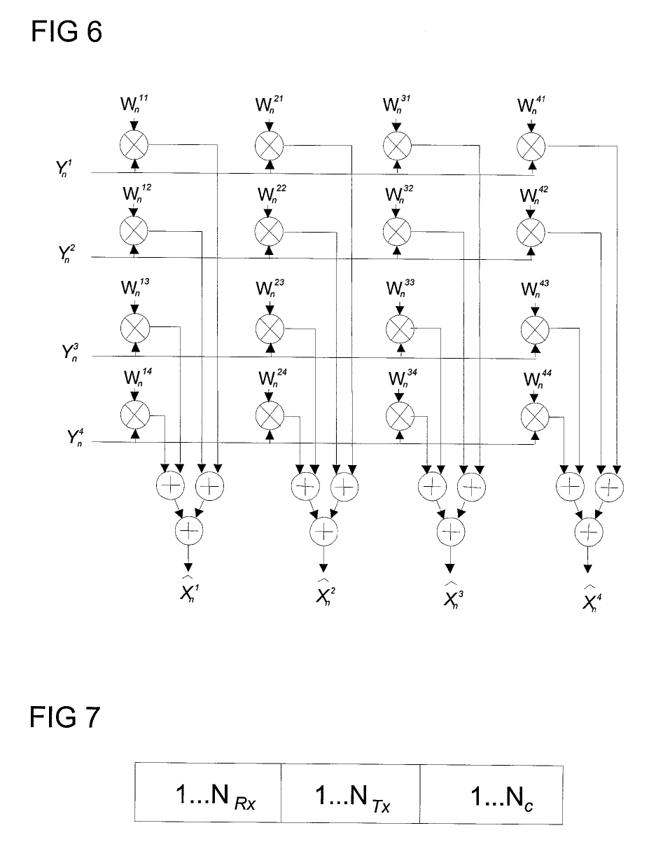

A so-called matrix-vector multiplication unit (MVME), implemented directly in the FPGA, is used for this purpose. In principle this unit multiplies a weighting matrix Wₙ valid for the current subcarrier by a current receive vector in accordance with the equation (1) in one clock pulse. This can advantageously be achieved by a pipeline structure, an example of which is shown in FIG. 6. Initially all multiplications occurring will be executed in parallel, for which purpose because of the complex operands 4*N_{Tx}*N_{Rx} multipliers implemented directly in hardware are preferably used, these already being implemented in large numbers in currently available FPGAs. Subsequently the required additions are executed in pairs until such time as an end result is available. The cascade of additions in FIG. 6 is generally similar to the KO principle in sporting contests. Thus in each clock pulse a matrix-vector multiplication is effectively executed, which advantageously enables a real time realization with simultaneously high data rates.

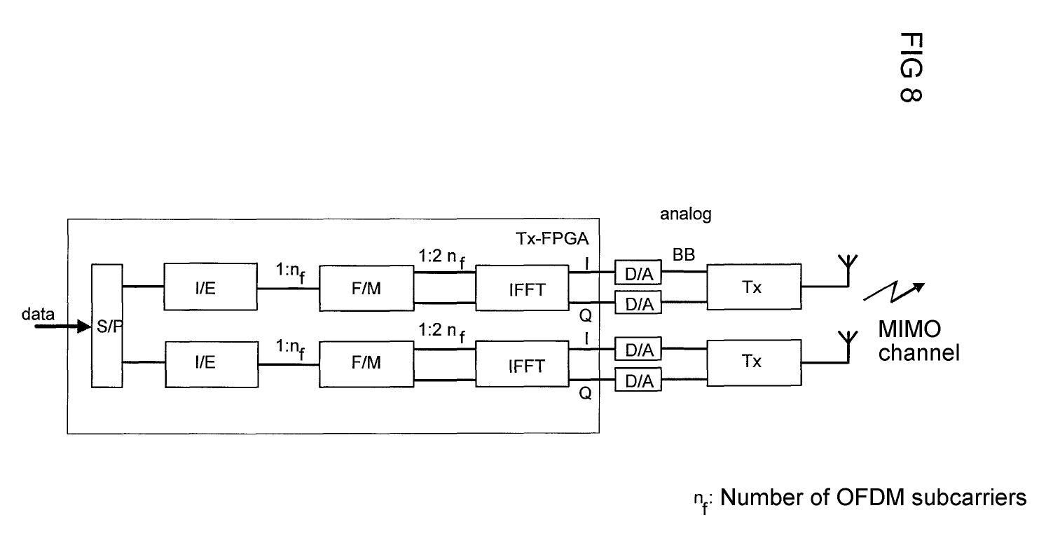

As already explained with reference to FIG. 3, receive signals are output subcarrier-by-subcarrier by the FFT unit. Because of this, the above-mentioned matrix-vector multiplication unit (MVME) can also be used subcarrier-by-subcarrier in a MIMO-OFDM system. To do this the weighting matrices Wₙ are for example first exchanged in a correct sequence by a suitable addressing of the operands. Preferably an addressing is selected for the registers used for this which allows a simple switchover between weighting matrices of the individual subcarriers, for example by a counter. An example of a possible addressing is shown in FIG. 7, however the individual fields can be interchanged in any order in the same way.

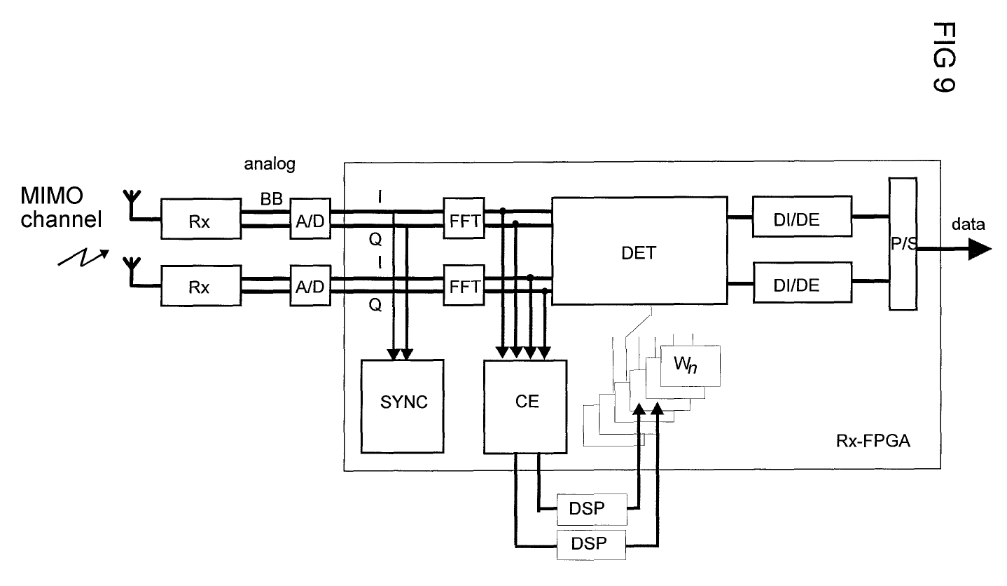

A transmitter-side and receiver-side integration will be described below with reference to FIGS. 8 and 9.

FIG. 8 shows a typical integration of a transmitter. Basically a parallel circuit of two OFDM transmit lines is implemented. Data is subdivided by a device for serial-parallel conversion S/P into a number of part data streams and interleaved and coded independently in a device I/E (Interleaving/Encoding) as well as additionally punctured if necessary to reduce the data rate. As an alternative to this however a common interleaving and encoding can be executed for the part data streams in the same way. All signals of importance for a transmission over the radio interface, such as the A, B and the C preamble, are generated in the Tx-FPGA and merged in the time multiplex with the data signals. This is undertaken in a framing and modulation device F/M, in which the transmission frame of the individual signal components is formed and modulated.

The transmission frames produced in this way subsequently undergo an inverse Fast Fourier Transformation IFFT and a cyclic prefix is inserted into the time domain signal. Alternatively the preambles can also be inserted into the time domain signal as complex sampling values. The digital transmit signals are subsequently converted by a digital-analog converter D/A into analog signals in the baseband BB, and modulated with IQ modulators in the transmitter station Tx onto the carrier-frequency, before, forming a MIMO channel, they are transmitted by transmit antennas over the radio interface. Instead of antennas, wired transmission can be used in the same way for the analog signals.

A typical integration in a receiver is shown in FIG. 9. Analog receive signals of the MIMO channel are mixed down in the relevant receive antennas of downstream receive units Rx in the baseband BB, and the complex baseband signals are subsequently digitized in relevant analog-digital converters A/D. The receiving devices Rx are for example direct downwards-converting receivers in this case. For a receive-side frame and symbol synchronization the corresponding A and B preamble signals in the time domain are evaluated in a synchronization device SYNC. The further signals undergo a Fast Fourier Transformation FFT after a correction of the frequency offsets not shown in the diagram and if necessary an estimation of the signal strength. In the frequency domain the signals preferably leave the Fast Fourier Transformation in order of subcarriers in order to simplify the implementation. Subsequently the signals are fed in parallel to a Channel Estimation (CE) unit as well as to a detection unit (DET).

The channel estimation is undertaken in this case on the previously described structure of the C preamble or training sequence. The digital estimation results for the matrices Hₙ are read into one or more DSPs, which for example can be implemented as a component of the FPGA Rx-FPGA. The weighting matrices Wₙ are subsequently stored in register pages arranged according to the individual subcarriers.

Generally the channel estimation can be performed in the time domain or the frequency domain. Estimation in the time domain can be implemented more efficiently with regard to the number of variables to be estimated, since the number of samplings is as a rule far lower than the number of subcarriers. However no estimators for the time domain providing an adequate power and realized in an FPGA are currently available. It should also be ensured that the number of channel coefficients for estimations in the frequency domains far exceeds the channel coefficients required for the so-called flat-fading channels.

The use of a separate correlation circuit (CC) for each channel coefficient would occupy appr. two thirds of a typically assumed XILINX X C2V6000 FPGA. However the correlation circuits can be re-used for all subcarriers by making slight modifications to them. An efficient implementation is possible based on the previous explanations for FIG. 3. After the Fast Fourier Transformation the subcarrier time grid of FIG. 3 is sampled line-by-line i.e. subfrequency-by-subfrequency, whereas the correlation is undertaken in the time domain, i.e. OFDM symbol-by-OFDM symbol.

An MVME, a linear MMSE (Minimal Mean Square Error) or in the general case a so-called flat-fading MIMO detector can be used as detector device DET for data reconstruction. The MVME performs a multiplication of all components of the receive vector from equation (1) in quasi-real-time with the weighting matrices Wₙ belonging to the current carrier index n in each case. In this case the corresponding matrix Wₙ is selected from the corresponding register pages for each subcarrier, which is symbolized in FIG. 9 by a switchable switch between the register pages. The signals reconstructed in this way are subsequently decoded in a decoding and de-interleaving unit, as well as the transmit-side interleaving being reversed. In a final device P/S for parallel-serial conversion, all part data streams are reassembled and are available as data for further processing.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-12. (canceled)

13. A method for signal transmission between a transmitting station and at least one receiving station of a communication system, where the transmitting station features at least two transmit antennas, comprising:
transmitting, from each of the at least two transmit antennas of the transmitting station, respective training sequences for channel estimation by the at least one receiving station sufficient to enable each transmit antenna to be identified by the at least one receiving station based on the respective training sequences.

14. A method as claimed in claim 13, wherein the signal transmission is performed according to a MIMO-OFDM transmission, with at least two subcarriers of a frequency band consisting of a number of subcarriers being modulated with one of the respective training sequences.

15. A method as claimed in claim 14, wherein the respective training sequences are distributed in each case over a number of consecutive OFDM symbols.

16. A method as claimed in claim 15, wherein the respective training sequences are embodied in each case as one of a preamble and a midamble.

17. A method as claimed in claim 16, wherein a length of the respective training sequences is selected depending on how many of the transmit antennas are used by the transmitting station.

18. A method as claimed in claim 17, wherein the respective training sequences are modulated for corresponding antennas with orthogonal codes.

19. A method as claimed in claim 18, wherein Hadamard sequences are used as the orthogonal codes.

20. A method as claimed in claim 19, wherein the respective training sequences are formed in each case exclusively from binary values for at least one of real and imaginary parts.

21. A method as claimed in claim 20, wherein the respective training sequences are scrambled in the frequency domain by multiplication by a binary sequence.

22. A method as claimed in claim 21, wherein the real and imaginary parts of a send signal are marked with the respective training sequences of a set of orthogonal sequences.

23. A station of a communication system having at least one receiving station, comprising:
at least two transmit antennas; and
means for transmitting, from each of the at least two transmit antennas, respective training sequences for channel estimation by the at least one receiving station sufficient to enable each transmit antenna to be identified by the at least one receiving station based on the respective training sequences.

24. A communication system, comprising:
at least one receiving station; and
at least one transmitting station having
at least two transmit antennas; and
means for transmitting, from each of the at least two transmit antennas, respective training sequences for channel estimation by said at least one receiving station sufficient to enable each transmit antenna to be identified by said at least one receiving station based on the respective training sequences.
